(19) United States
(12) Patent Application Publication
(10) Pub. No.: US 2013/0051330 A1
(43) Pub. Date: Feb. 28, 2013

(54) Automatic Resource Allocation For ARQ Feedback

(71) Applicants: Yan Qun Le, Beijing, (CN); Yi Wu, Beijing (CN)

(72) Inventors: Yan Qun Le, Beijing, (CN); Yi Wu, Beijing (CN)

(21) Appl. No.: 13/003,434

(22) PCT Filed: Jul. 11, 2008
(86) PCT No.: PCT/EP2008/005690

§ 371 Date: Aug. 1, 2011

(51) Int. Cl. H04W 72/04

(52) U.S. Cl. 370/329

(57) ABSTRACT

A method (S400); apparatus, and computer program product, wherein it is determined whether a transmission resource request has been received from a receiving end to be scheduled for retransmission feedback (S405). Then, an available transmission resource is allocated to a receiving end (S406) for which retransmission data is pending for retransmission feedback and from which no request for transmission resource has been received (S4005).

### FIELD OF THE INVENTION

The present invention relates to a method, apparatus, and computer program product for allocating transmission resource for retransmissions in a wireless communication system, such as an OFDM (Orthogonal Frequency Division Multiplexing) based transceiver system (e.g. wireless local area network (WLAN), Worldwide Interoperability for Microwave Access (WiMAX), and 3.9G/Long Term Evolution (LTE)).

### BACKGROUND OF THE INVENTION

High-data-rate communications as defined in the WiMAX IEEE 802.16-2004 standard may pave the way for true broadband, multimedia services over wireless networks. Based on orthogonal-frequency-division-multiplex (OFDM) techniques, the WiMAX physical-layer (PHY) and media-access-control (MAC) protocols are outlined in the Institute of Electrical and Electronics Engineers (IEEE) 802.16-2004 standard.

The generic MAC header (GMH) contains details of the MAC protocol data units (MPDU). The header can contain e.g., the connection identity (CID) that defines the connection that a packet is servicing, the length of the frame and bits to qualify the presence of the cyclic redundancy code (CRC), sub headers and an indication whether or not the payload is encrypted and if so, with which key.

The payload can contain a management message or transport data. Specific connections may be set aside as management connections which carry management messages. All other channels may be transport channels that may not carry management messages. A payload in a transport connection can contain a MAC service data unit (MSDU), fragments of MSDUs, aggregates of MSDUs, aggregates of fragments of MSDUs, bandwidth requests or retransmission requests according to the MAC rules on bandwidth requesting, fragmentation, packing and retransmission.

To request changes to the granted characteristics of a connection, a 6-byte bandwidth request header may be transmitted in place of the GMH. The header type (HT) bit is set to “1” to indicate that the header is a bandwidth request header and not a GMH. A bandwidth request (BR) field indicates the number of uplink bytes of bandwidth being requested. The 6-bit type field can take the value “0” to indicate an incremental bandwidth request or a value of “1” to indicate an aggregate request. A CID field may indicate the connection for which the bandwidth request is being made. Thus, the bandwidth request does not need to be only for a connection that is specified in the GMH. It can apply to any connection specific to the requesting subscriber station (SS).

Additionally, a piggyback request is a 16-bit number that represent the number of uplink bytes of bandwidth being requested for the connection. The piggyback request can be used to explicitly indicate to a serving base station (BS) the amount of uplink bandwidth that the SS want to be granted to it.

An automatic retransmission request (ARQ) is a means by which either end of the link can request the retransmission of part of an MSDU, generally as a result of it being received erroneously. A system parameter block size is defined. MSDUs are considered to be made from a number of blocks of the same size, except for the final block which may be smaller. To request the retransmission of blocks (NACK) or to indicate the successful reception of blocks (ACK), the ARQ feedback payload is included in the payload. Thus, ARQ is a retransmission option in the MAC layer, which improves system performance by retransmitting MAC ARQ blocks that have been lost or garbled. ARQ may be enabled on a per-connection basis. The ARQ feedback information can be sent as a standalone MAC management message on the appropriate basic management connection, or it can be piggybacked on an existing connection. ARQ feedback cannot be fragmented. If no data on any existing connection can be piggybacked, it has to do BR contention to request slots to send ARQ feedback message.

If no data can be piggybacked, BR contention is required by the ARQ feedback to request slots. However, the collision possibility of BRs is quite big when lots of SSs contend for the resource, and a several frames delay of the BR affects the timely transmission of ARQ feedback message and accordingly affects the throughput of the connection.

FIG. 2 shows a standalone transmission process of an ARQ feedback in the uplink (UL) direction from the SS to the BS. A frame sequence 1 to N+4 is shown as a time reference to the below processing steps S101 to S105.

In a first step S101, the SS (e.g. mobile station (MS)) selects a Code Division

Multiple Access (CDMA) code and initiates a contention resolution. After a contention delay of N frames, the serving BS allocates slots for BR of the received CDMA code by an UL-MAP message (step S102). Then in step S103, the MS transmits the BR according to the required transmission resources. In step S104, the serving BS allocates UL resource according to the received BR. Finally, the MS transmits in S105 the desired ARQ feedback. Hence, an N-frame delay (e.g. contention delay) including potential contention latency enlarges the ARQ round trip time and thus deteriorates throughput.

### SUMMARY

In an embodiment of one transmission end a method comprises:
determining whether a request for transmission resource has been received from a receiving end which is to be scheduled for retransmission feedback; and
allocating an available transmission resource to a receiving end for which retransmission data is pending for retransmission feedback and for which said determining indicates the no request for transmission resource has been received.

Furthermore, in an embodiment of an opposite transmission end a method comprises:
receiving a transmission resource allocation for retransmission feedback at a receiving end;
checking the size of a pending retransmission feedback;
transmitting said pending retransmission feedback if said pending retransmission feedback can be accommodated in said received transmission resource allocation; and
transmitting a request for transmission resource if said checking indicates that said pending retransmission feedback cannot be accommodated in said received transmission resource allocation.

Additionally, in an embodiment an apparatus at a transmission end comprises:
a request identifier (e.g. determination means) for determining whether a request for transmission resource has been received from a receiving end which is to be scheduled for retransmission feedback; and
a resource allocator (e.g. allocation means) for allocating an available transmission resource to a receiving end for which retransmission data is pending for retransmission feedback and for which said request identifier indicates the no request for transmission resource has been received.

Further, in an embodiment an apparatus at an opposite transmission end comprises:
a receiver (e.g. receiving means) for receiving a transmission resource allocation for retransmission feedback at a receiving end;
a size checker (e.g. checking means) for checking the size of a pending retransmission feedback; and
a transmitter or transmitting means for transmitting said pending retransmission feedback if said pending retransmission feedback can be accommodated in said received transmission resource allocation, and for transmitting a request for transmission resource if said size checker indicates that said pending retransmission feedback cannot be accommodated in said received transmission resource allocation.

Accordingly, by the usage of the free or available transmission resource (e.g. transmission slots etc.), the retransmission feedback can be sent timely and more retransmission blocks can be sent, so that the total throughput can be increased. Additionally, due to less contention for transmission resource requests, connections are seldom to be disconnected and fairness can be improved or restored. Moreover, collision possibility with the transmission resource requests from other receiving ends (e.g. SSs) can be reduced and other transmission resource requests are more likely to succeed.

In a specific implementation according to an embodiment, the transmission resource request may be a bandwidth request. As an additional implementation option, the allocated transmission resource may comprises at least one transmission slot.

Optionally, the allocation of available transmission resource of a plurality of receiving ends may be distributed by a distributing means among a plurality of transmission frames to thereby increase allocation fairness. As an example, the distributing may be performed at least in part by randomly accessing a terminal queue and marking those receiving ends for which available transmission resource has been allocated.

Implementation of the proposed estimation may be based at least in part on a computer program comprising code means for producing the above method steps when run on a computer device. The computer program may be stored on a computer-readable medium or may be downloadable from a private or public network.

Further advantageous modifications are defined in the dependent claims.

### BRIEF DESCRIPTION OF THE DRAWINGS

In the following, the present invention will be described in greater detail based on embodiments with reference to the accompanying drawings, in which:

FIG. 1 shows a schematic block diagram of a communication system in which the present invention can be implemented;

FIG. 2 shows a schematic frame-related flow diagram of a standalone retransmission procedure;

FIG. 3 shows a schematic block diagram of a base station device according to an embodiment;

FIG. 4 shows a schematic block diagram of a terminal device according to an embodiment;

FIG. 5 shows a flow diagram of an enhanced resource allocation for retransmission according to an embodiment;

FIG. 6 shows a schematic block diagram of a software-based implementation according to an embodiment;

FIG. 7 shows a diagram indicating a total throughput comparison;

FIG. 8 shows a diagram indicating performance of a conventional resource allocation process; and

FIG. 9 shows a diagram indicating performance of the enhanced resource allocation.

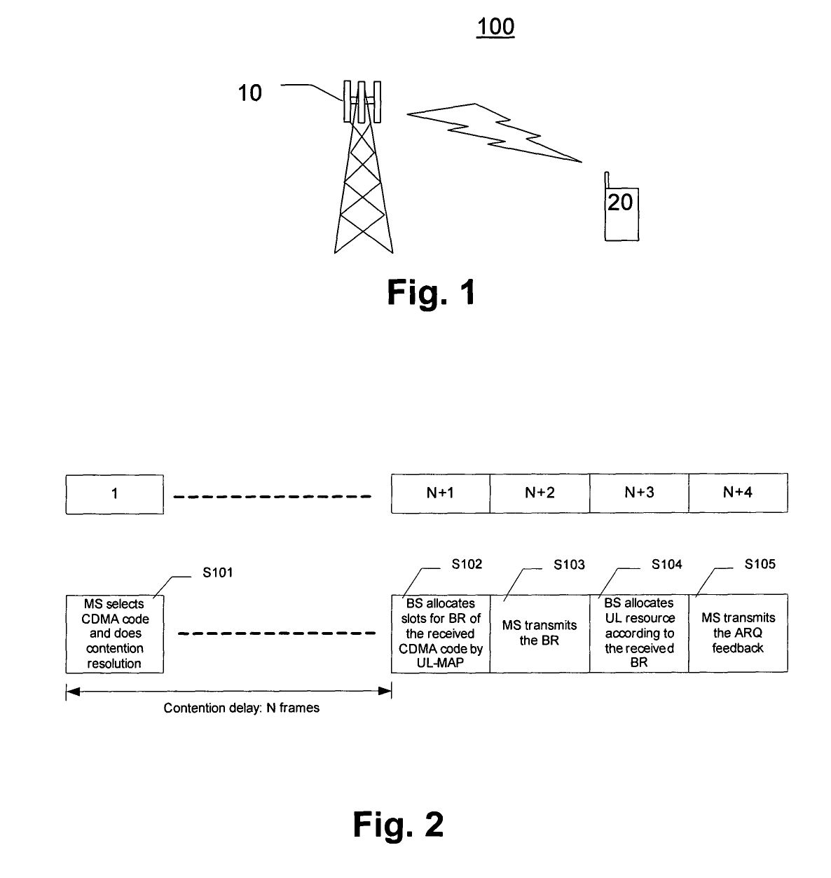

### DESCRIPTION OF THE EMBODIMENT

An embodiment will now be described based on an slot allocation process for ARQ in a wireless network environment. The proposed resource allocation functionality can be applied in any transmitter, receiver or transceiver arrangement or module provided in a terminal device or network device. It is applicable to both uplink and downlink transmissions.

FIG. 1 depicts a communication system 100 that implements wireless communications in accordance with the IEEE 802.16 broadband wireless access standards (such as WiMax) e.g. for metropolitan area networks (MANs). WiMax specifies the use of orthogonal frequency division multiplexing (OFDM) as a modulation scheme to communicate data between a signal source, such as a base station 10, and a subscriber station, such as a mobile station 20. OFDM enables communication of a large amount of data over a limited bandwidth by allocating the data among multiple smaller sub-signals, and then simultaneously transmitting the sub-signals using different sub-carriers.

According to various embodiments, enhanced retransmission efficiently is achieved by utilizing free transmission resource (e.g. free slots) after scheduling to speed up the retransmission process by reserving a UL channel for the SS to send back the retransmission feedback without prior bandwidth contention.

More specifically, considering a retransmission connection in downlink (DL), if the BS hasn't received any transmission resource request (e.g. bandwidth request) from the peer SS, it may mean that after the last retransmission period, the SS didn't get the opportunity to send the retransmission feedback by piggyback or based on a transmission resource request. Therefore, if there is still transmission resource available in the BS scheduler after periodical data grants, resource allocation or other resource requests from SSs, transmission resource (e.g. one or more slots or other kinds of resources) can be allocated to or reserved for an SS. This can be done for those SSs which have a retransmission enabled connection, and also from which the BS has not received any transmission resource request while there are still retransmission packets pending in the buffer for acknowledgement.

When being granted, the SS (retransmission receiver) may check the size of pending retransmission feedback first. If it can be accommodated in the allocated transmission resource, the SS could send it immediately. Otherwise, the SS could send a request for more transmission resource (e.g. larger bandwidth grant).

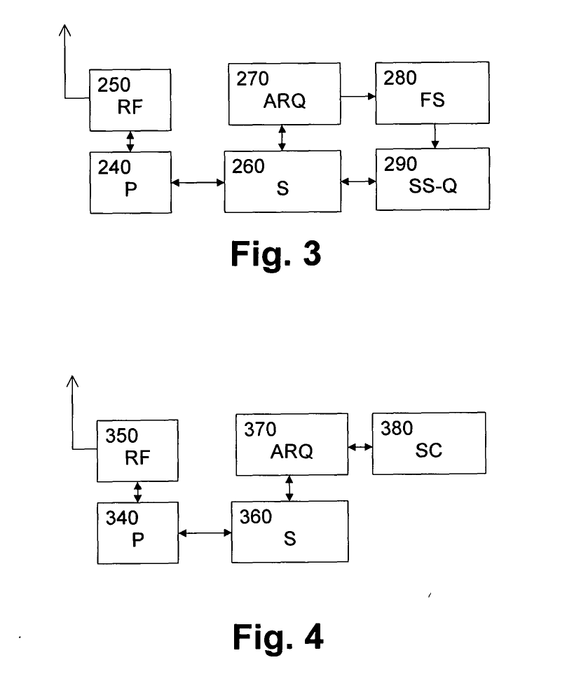

FIG. 3 shows a schematic block diagram of those components which are useful to describe an embodiment of the present invention. These components may be provided in a radio frequency (RF) transmitter or transceiver of a BS or other wireless network access device that transmits user and control data. Such components can be, for example, integrated as a chip or chip set of the BS.

The exemplary components or blocks shown in FIG. 3 comprise an RF stage 250, a processor (P) 240 (e.g. central processing unit (CPU), digital or analog signal processor or the like), a scheduler (S) 260, an SS queue (SS-Q) 290 for successively buffering identities (IDs) of served SSs waiting to be scheduled, a retransmission handling functionality or unit (ARQ) 270, and a flag setting functionality or unit (FS) 280 for setting a selection flag for each buffered SS identity. In operation, when a communication signal, for instance an OFDM signal that was transmitted in accordance with the IEEE 802.16 broadband wireless access standards (WiMax), is received by the RF stage 250 via an antenna, it is converted into a digital signal and subjected to a fast fourier transformation (FFT) to obtain output complex signal values which are supplied to the processor 240.

According to the 802.16 MAC specifications, on-air timing is based on consecutive frames that are divided into slots. The size of frames and the size of individual slots within the frames can be varied on a frame-by-frame basis, under the control of the scheduler 260. This allows effective allocation of transmission resources to meet the demands of active connections with their granted quality-of-service (QoS) properties. The QoS parameters for a connection can be varied by the SS making requests to the BS to change them while a connection is maintained. The BS allocates dedicated or shared resources periodically to each SS. The allocated resources can be used by the SS to request bandwidth. This process is called polling. Polling may be done either individually (unicast) or in groups (multicast). Multicast polling is done when there is insufficient bandwidth to poll each SS individually. When polling is done in multicast, the allocated slot for making bandwidth requests is a shared slot, which every polled SS attempts to use. WiMAX defines a contention access and resolution mechanism for the case when more than one SS attempts to use the shared slot. If it already has an allocation for sending traffic, the SS is not polled. Instead, it can be allowed to request more bandwidth by transmitting a stand-alone BR MPDU, sending a BR using a ranging channel, or piggybacking a BR on generic MAC packets.

Available QoS service classes may comprise several services for different purposed. For example, an unsolicited grant service (UGS) may be provided for constant bit-rate (CBR) services,. Additionally, a real time polling service (rtPS) may be provided for variable bit-rate services which are sensitive to delay. Furthermore, an extended real time polling service (ertPS) may be provided for e.g. voice over IP (VoIP) services with silence suppression or CBR services with gaps. Further, a non-real time polling service (nrtPS) may be provided for time insensitive services which require a minimum bandwidth allocation. In addition, a best effort service may be provided for services with unspecified variable bit rate and delivery time, depending on the current traffic load.

As an optional feature in order to avoid the situation that the SS number is too big and free slots are not enough to satisfy all SSs, one of those SS, from which no BR has been received, is randomly selected from the SS queue 290, and one slot is allocated to the selected SS. Additionally, the flag setting unit 280 is controlled to set the selection flag of the selected SS. Of course other kind of marking can be used instead of flag setting. The allocation continues until no free slot is left or all SSs have been served.

During allocation of free slots for UL connections, the ARQ handling unit 270 controls the scheduler 260 to allocate for example one slot for those served SSs which have ARQ connections despite of no BR.

Considering an ARQ connection in downlink, if the ARQ handling unit 270 determines—e.g. based at least in part on information received or requested from the scheduler 260 or the processor 240—that the BS hasn't received any BR from the peer SS, it concludes that the concerned SS didn't get the opportunity to send an ARQ feedback by piggyback or by BR after the last ARQ transmission period. At first periodical data grants of UGS and ertPS, allocation for rtPS and nrtPS, and other BRs from SSs are scheduled. Then, if there are still free uplink slots left in the BS scheduler 260, the ARQ handling unit 270 allocates for example one slot for the concerned SS, provided that the concerned SS has an ARQ-enabled connection, and the BS has not received any BR from the concerned SS while there are still ARQ packets pending in the SS data queue 290 for acknowledgement. As an alternative, more than one slot or an individual number of slots can be allocated for the concerned SS.

FIG. 4 shows a schematic block diagram of those components which are useful to describe another embodiment of the present invention. These components may be provided in a radio frequency (RF) receiver or transceiver of an SS or other terminal device or receiving end that receives user and control data. Such components can be, for example, integrated as a chip or chip set of the SS.

The exemplary components or blocks shown in FIG. 4 comprise an RF stage 350, a processor (P) 340 (e.g. central processing unit (CPU), digital or analog signal processor or the like), a scheduler (S) 360, a retransmission handling functionality or unit (ARQ) 370, and a size checking functionality or unit (SC) 380 for checking the size of an ARQ feedback. In operation, when a communication signal, for instance an OFDM signal that was transmitted in accordance with the IEEE 802.16 broadband wireless access standards (WiMax), is received by the RF stage 350 via an antenna, it is converted into a digital signal and subjected to a fast fourier transformation (FFT) to obtain output complex signal values which are supplied to the processor 340.

When the ARQ handling unit 370 receives information that transmission resource (e.g. one slot in the present exemplary embodiment) is granted for an ARQ enabled connection, the ARQ handling unit first initiates a check of the size of the pending ARQ feedback of the concerned ARQ enabled connection by the size checking unit 380 (which may as well be an integrated functional part of the ARQ handling unit 370). If the checking result indicates that the ARQ feedback can be accommodated in the allocated transmission resource, the SS is controlled to send the ARQ feedback immediately. Otherwise, the ARQ handling unit 370 controls the scheduler 360 to send a BR for larger bandwidth grant.

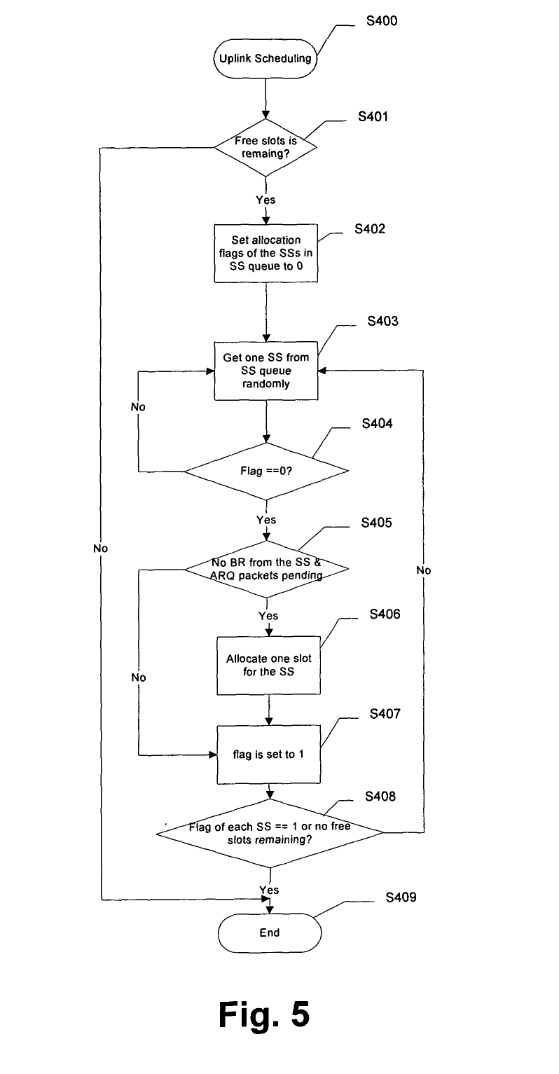

FIG. 5 shows a flow diagram of the proposed resource allocation procedure according to a further embodiment which can be implemented at the BS.

After an initial uplink scheduling in step S400 has been finished, it is checked in step S401 whether any free transmission slots have remained for the proposed enhanced resource allocation. If it is determined in step S401 that no free transmission slot has remained, the flow branches off to the end of the procedure, e.g., the processing ends in step S409. If free transmission slots are still available, an identifier (ID) of an SS is randomly picked or fetched from the SS queue 290 (e.g. by the scheduler 260 under control of the retransmission handling unit 270) in step S403. In step S402, selection flags of the SSs in the SS queue 290 are set to “0”. Then, it is checked in step S404 whether the selection flag of the fetched SS ID is currently set to “0”. If it is determined in step S404 that the selection flag is currently not set to “0”, the procedure jumps back to step S403 where another SS ID is fetched from the SS queue 290. This is repeated until the first SS ID with selection flag “0” has been found. In the following step S405 it is checked whether the fetched SS has not generated a BR and has ARQ packets pending. If both is true, one transmission slot is allocated to the SS with the fetched ID in step S406 and the selection flag of the selected SS is set to “1” in step S407. Otherwise, if at least one of the above conditions is not met, the procedure skips step S406 and continues with step S407 where the selection flag of the selected SS is directly set to “1” without any resource allocation. If it is then determined in step S408 that no free slots are remaining in the SS queue 290 or the selection flag of each queued SS is set to “1”, the procedure ends. If it is determined in step S408 that there are still free transmission slots remaining and not all selection flags in the SS queue 290 are set to “1”, the procedure jumps back to step S403 in order to get or fetch the next SS ID from the SS queue 290.

Thus, during the allocation of free slots for uplink connections, the above procedures ensure that one slot is fairly allocated for those SSs which have ARQ connections despite of no BR.

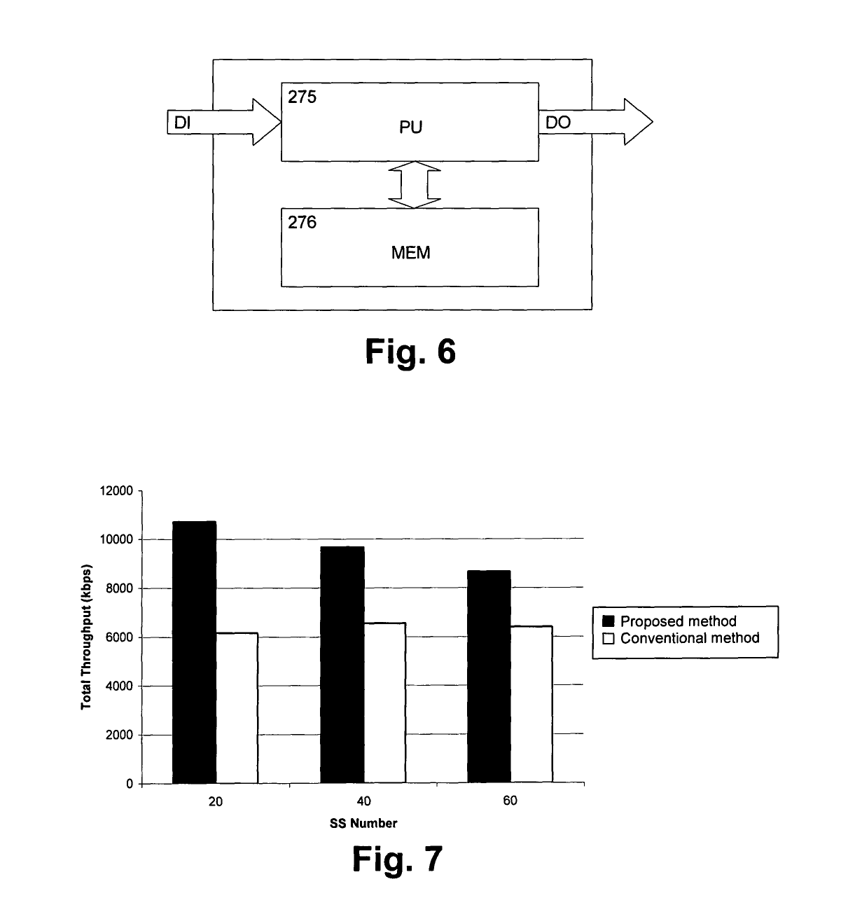

FIG. 6 shows a schematic block diagram of an alternative software-based embodiment of the proposed functionalities at the BS or SS. The required functionalities can be implemented for example in the ARQ handling unit 270 or 370, respectively, or any similar processing stage of a transmitter or transceiver. This embodiment comprises a processing unit (PU) 275, which may be any processor or computer device with a control unit which performs control based on software routines of a control program stored in a memory (MEM) 276. Program code instructions are fetched from the memory 276 and are loaded to the control unit of the processing unit 275 in order to perform the processing steps of the above functionalities described in connection with the block diagram of FIG. 3 or 4 or the flow diagram of FIG. 5. These processing steps may be performed on the basis of input data DI and may generate output data DO, wherein the input data DI may correspond to a scheduled SS ID at the network side (e.g. BS) or a resource allocation information at the terminal side (e.g. SS). The output data DO may correspond to the signaled resource allocation (e.g. slot allocation or other type of bandwidth or channel allocation) at the network side or to a resource request or retransmission feedback at the terminal side (e.g. SS). Of course, the procedure can be applied in the uplink direction as well, so that terminal side and network side could be exchanged.

FIG. 7 shows a diagram depicting simulation results of total throughput versus number of served SSs of the proposed enhanced resource allocation scheme (black bars) in comparison with a conventional resource allocation (white bars). By the proposed usage of free transmission resources (e.g. available transmission slots), the ARQ feedback can be sent timely and more ARQ blocks can be sent in the proposed allocation scheme. Accordingly the total throughput can be increased.

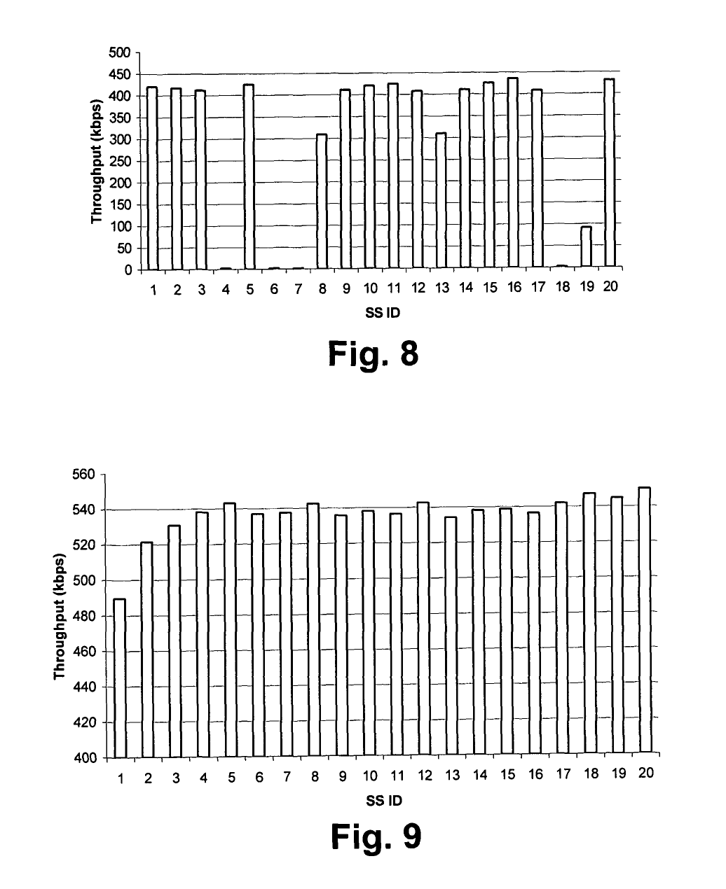

FIGS. 8 and 9 show diagrams depicting simulation results of throughput of the conventional resource allocation scheme (FIG. 8) and the proposed enhanced resource allocation scheme (FIG. 9) in case of a transmission control protocol (TCP) usage. In the simulation example of FIGS. 8 and 9, a total of 20 SSs are scheduled and each has a DL file transfer protocol (FTP) connection. As can be gathered from FIG. 8, plural BR contentions lead to an unequal distribution of throughput among served SSs. In contrast thereto, FIG. 9 reveals that due to less BR contentions by the proposed allocation scheme, the TCP connections are seldom disconnected and TCP fairness can be restored.

Like any other receiver or transmitter functionality, the above embodiments can be implemented in hardware by a discrete analog or digital circuit, signal processor, or a chip or chip set (e.g. an ASIC (Application Specific Integrated Circuit)), or in software either in an ASIP (Application Specific Integrated Processor), a DSP (Digital Signal Processor), or any other processor or computer device.

In summary, a method, apparatus, and computer program product have been described, wherein it is determined whether a transmission resource request has been received from a receiving end to be scheduled for retransmission feedback. Then, an available transmission resource is allocated to a receiving end for which retransmission data is pending for retransmission feedback and from which no request for transmission resource has been received.

It is noted that the present invention can be implemented or used in any transmission system where scheduling with resource allocation is performed. More specifically, the present invention can be applied in radio systems like e.g. WiMAX as currently standardized in 3GPP for WCDMA (Wideband Code Division Multiple Access), as well as 3GPP E-UTRAN (Enhanced Universal Mobile Telecommunications System (UMTS) Terrestrial Radio Access Network), such as LTE (Long Term Evolution) or 3.9G. These radio access technologies (e.g. WLAN, WiMAX, E-UTRAN or 3G LTE) may involve multiple-input multiple-output (MIMO) systems or multi-beam/multi-antenna transmitter or receiver devices (e.g. base station devices, access points or other access devices) capable of receiving signals via different receiving paths and/or channels. The proposed resource allocation is not restricted to a slot allocation, but may as well be based on an allocation of other parameters (e.g. time, frequency, code, etc.) which influence available transmission resources.

As already mentioned, the embodiments can be realized in hardware, software, or a combination of hardware and software. A typical combination of hardware and software can be a processing system with an application that, when being loaded and executed, controls the processing system such that it carries out the methods described herein. The embodiments also can be embedded in an application product, which comprises all the features enabling the implementation of the methods described herein, and which when loaded in a processing system is able to carry out these methods.

The terms “computer program,” “software,” “application,” variants and/or combinations thereof, in the present context, mean any expression, in any language, code or notation, of a set of instructions intended to cause a system having an information processing capability to perform a particular function either directly or after either or both of the following: a) conversion to another language, code or notation; b) reproduction in a different material form. For example, an application can include, but is not limited to, a subroutine, a function, a procedure, an object method, an object implementation, an executable application, an applet, a servlet, a source code, an object code, a shared library/dynamic load library and/or other sequence of instructions designed for execution on a processing system.

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (e.g., open language). This invention can be embodied in other forms without departing from the spirit or essential attributes thereof. Accordingly, the above predetermined embodiments may vary within the scope of the attached claims.

1. A method comprising:
determining whether a request for transmission resource has been received from a receiving end which is to be scheduled for retransmission feedback; and
allocating an available transmission resource to a receiving end for which retransmission data is pending for retransmission feedback and for which said determining indicates that no request for transmission resource has been received.

2. The method according to claim 1, wherein said request for transmissions resource is a bandwidth request.

3. The method according to claim 1, wherein said allocated transmission resource comprises at least one transmission slot.

4. The method according to claim 1, further comprising distributing said allocation of available transmission resource of a plurality of receiving ends among a plurality of transmission frames.

5. The method according to claim 4, further comprising performing said distribution at least in part by randomly accessing a terminal queue and marking those receiving ends for which available transmission resource has been allocated.

6. A method comprising:
receiving a transmission resource allocation for retransmission feedback at a receiving end;
checking the size of a pending retransmission feedback;
transmitting said pending retransmission feedback if said pending retransmission feedback can be accommodated in said received transmission resource allocation; and
transmitting a request for transmission resource if said checking indicates that said pending retransmission feedback cannot be accommodated in said received transmission resource allocation.

7. A method according to claim 6, wherein said request for transmission resource is a bandwidth request.

8. The method according to claim 6, wherein said transmission resource allocation comprises at least one transmission slot.

9. An apparatus comprising at least one processor; and at least one memory including computer program code, the at least one memory and the computer program code configured to with the at least one processor cause the apparatus to perform at least the following:
to determine whether a request for transmission resource has been received from a receiving end which is to be scheduled for retransmission feedback; and
to allocate an available transmission resource to a receiving end for which retransmission data is pending for retransmission feedback and for which said request identifier indicates that no request for transmission resource has been received.

10. The apparatus according to claim 9, wherein the at least one memory and the computer program code are further configured to cause the apparatus to determine whether a bandwidth request has been received from said receiving end.

11. The apparatus according to claim 9, wherein the at least one memory and the computer program code are further configured to cause the apparatus to allocate at least one transmission slot.

12. The apparatus according to claim 9, the at least one memory and the computer program code are further configured to cause the apparatus to distribute said allocation of available transmission resource of a plurality of receiving ends among a plurality of transmission frames.

13. The apparatus according to claim 12, wherein the at least one memory and the computer program code are further configured to cause the apparatus to mark those receiving ends for which available transmission resource has been allocated.

14-30. (canceled)

31. The apparatus according to claim 9, wherein the apparatus is embodied in a base station device.

32. The apparatus according to claim 9, wherein the apparatus is embodied in an integrated circuit.

33. The method according to claim 1, further comprising determining whether the available transmission resources remain after an initial uplink scheduling, where determining whether the request for transmission resource has been received occurs in response to determining that the available transmission resources remain.

34. The method according to claim 1, where the receiving end is a selected receiving end and the method further comprises:
fetching a potential receiving end from a queue comprising a plurality of receiving ends;
determining whether the potential receiving end has been previously selected; and
in response to determining that the potential receiving end has not been previously selected, selecting the potential receiving end as the selected receiving end.

35. The method according to claim 34, where determining whether the potential receiving end has been previously selected comprises determining whether a selection flag for the potential receiving end has been set.

36. The method according to claim 35, in response to allocating the available transmission resource to the selected receiving end, setting the selection flag for the selected receiving end.

37. The method according to claim 35, in response to determining that the request for transmission resource has been received for the selected receiving end, setting the selection flag for the selected receiving end.
